(19) United States
(12) Patent Application Publication
(10) Pub. No.: US 2013/0112456 A1
(43) Pub. Date: May 9, 2013

(54) ELECTRICAL OUTLET COVER

(71) Applicant: Amy Michelle Nedrich, Canonsburg (US)

(72) Inventor: Amy Michelle Nedrich, Canonsburg (US)

(21) Appl. No.: 13/629,576

(22) Filed: Sep. 27, 2012

Related U.S. Application Data
(60) Provisional application No. 61/556,607, filed on Nov. 7, 2011.

(51) Int. Cl. H02G 3/14

(52) U.S. Cl. 174/66

(57) ABSTRACT

An electrical outlet cover that is safe, accessible/removable and aesthetically pleasing in design can be used to cover outlets in older homes that may not be up to today's electrical codes, thus improving the safety of the home. The electrical outlet cover can also prevent children or pets from accessing any part of the wall outlet. The electrical cover can be designed to cover an entire electrical outlet, or can be designed to cover an unused half of a wall outlet. The electrical cover can be painted or designed similar to the wall to readily blend in with its surroundings.

### CROSS-REFERENCE TO RELATED APPLICATION

This application claims the benefit of priority of U.S. provisional application No. 61/556,607, filed Nov. 7, 2011, the contents of which are herein incorporated by reference.

### BACKGROUND OF THE INVENTION

The present invention relates to electrical outlet covers and, more particularly, to a seamless, removable wall plate that completely covers or half-covers electrical outlets.

Electrical outlets are typically placed through a home or business for ready access to electrical power. Many times, these electrical outlets are positioned where children can easily reach them. A child may insert an electrically conductive object or a finger into such an electrical outlet, resulting in an electric shock.

There are many items on the market today that help “child-proof” electrical outlets. While often achieving the desired purpose, these items can be difficult to remove if access to the outlet is needed, may not fit all designs of outlets, and may be aesthetically unpleasing.

In older homes, there may be one or more electrical outlets that are not up to code or unsafe to use. There is currently nothing available for the user that wishes to cover such an outlet in an aesthetically pleasing manner.

As can be seen, there is a need for an electrical outlet cover that can be easy to use, removable and aesthetically designed.

### SUMMARY OF THE INVENTION

In one aspect of the present invention, an electrical outlet covering device comprises a cover; and a set of prongs extending from a back side of the cover, the set of prongs operable to fit into an electrical outlet, wherein the cover is adapted to fit over a wall plate cover of the electrical outlet.

In another aspect of the present invention, an electrical outlet covering device comprises a cover; a set of prongs extending from a back side of the cover, the set of prongs operable to fit into an electrical outlet rounded edges disposed about an outer periphery of the cover; and a separation seam disposed from a first side to a second side of the cover, wherein the cover is adapted to fit over a wall plate cover of the electrical outlet.

In another aspect of the present invention, an electrical outlet covering device comprises a cover; and a set of prongs extending from a back side of the cover, the set of prongs operable to fit into an electrical outlet, wherein the cover is adapted to fit over half or more of a wall plate cover of the electrical outlet.

These and other features, aspects and advantages of the present invention will become better understood with reference to the following drawings, description and claims.

### BRIEF DESCRIPTION OF THE DRAWINGS

FIG. 1 is a perspective view of an electrical outlet covered by an electrical outlet cover according to an exemplary embodiment of the present invention;

FIG. 2 is an exploded perspective view of the electrical outlet and electrical outlet cover of FIG. 1;

FIG. 3 is a rear perspective view of the electrical outlet cover of FIG. 1;

FIG. 4 is a cross-sectional view taken along line 4-4 of FIG. 1;

FIG. 5 is a rear perspective view of an electrical outlet cover having a separation seam for creating a half-sized electrical outlet cover;

FIG. 6 is a rear perspective view of a half-sized electrical outlet cover turned to cover an upper outlet of an electrical outlet; and

FIG. 7 is a rear perspective view of the half-sized electrical outlet cover of FIG. 6, turned to cover a lower outlet of the electrical outlet.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an electrical outlet cover that is safe, accessible/removable and aesthetically pleasing in design. The electrical outlet cover can be used to cover outlets in older homes that may not be up to today's electrical codes, thus improving the safety of the home. The electrical outlet cover can also prevent children or pets from accessing any part of the wall outlet. The electrical cover can be designed to cover an entire electrical outlet, or can be designed to cover an unused half of a wall outlet. The electrical cover can be painted or designed similar to the wall to readily blend in with its surroundings.

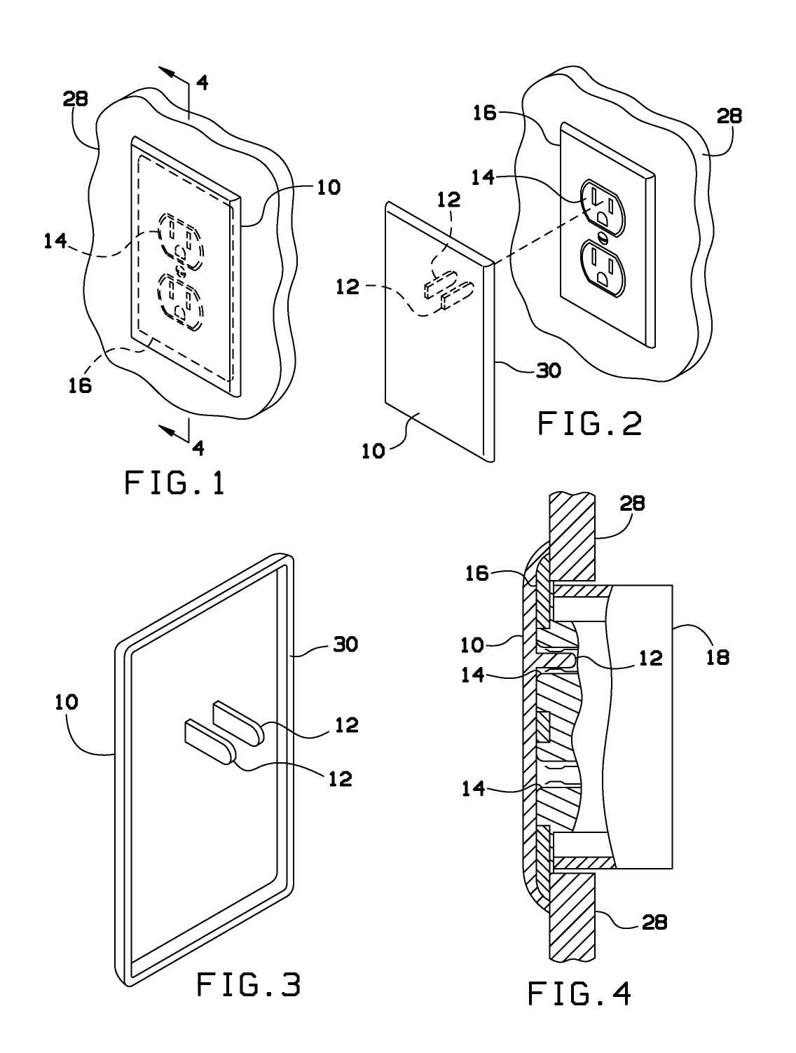

Referring now to FIGS. 1 through 4, an electrical outlet cover 10 can include a set of prongs 12 that are spaced apart and sized to fit into an electrical outlet 14. The prongs 12 can be the same size (non-polarized) so that the prongs 14 can fit into an upper one of the plugs in the outlet 14 (as shown in FIGS. 1, 2 and 4), or so that the electrical outlet cover 10 can be turned upside down and fit into a lower one of the plugs in the outlet 14. The prongs 12 are typically made of the same material as the electrical outlet cover 10 and are typically made integral therewith.

The prongs 12 allow the electrical outlet cover 10 to fit over the outlet 14 without requiring the user to remove the electrical wall plate 16 from the electrical outlet box 18 inside the wall 28.

The electrical outlet cover 10 can be designed to fit completely over an electrical outlet wall plate 16. The electrical outlet cover 10 can include rounded edges 30 that can be disposed against a wall 28, as shown in FIG. 4. The front face and the sides of the electrical outlet cover 10 that are in view can be painted, wall papered, or otherwise designed as desired by the user, often in a manner similar to the surrounding wall.

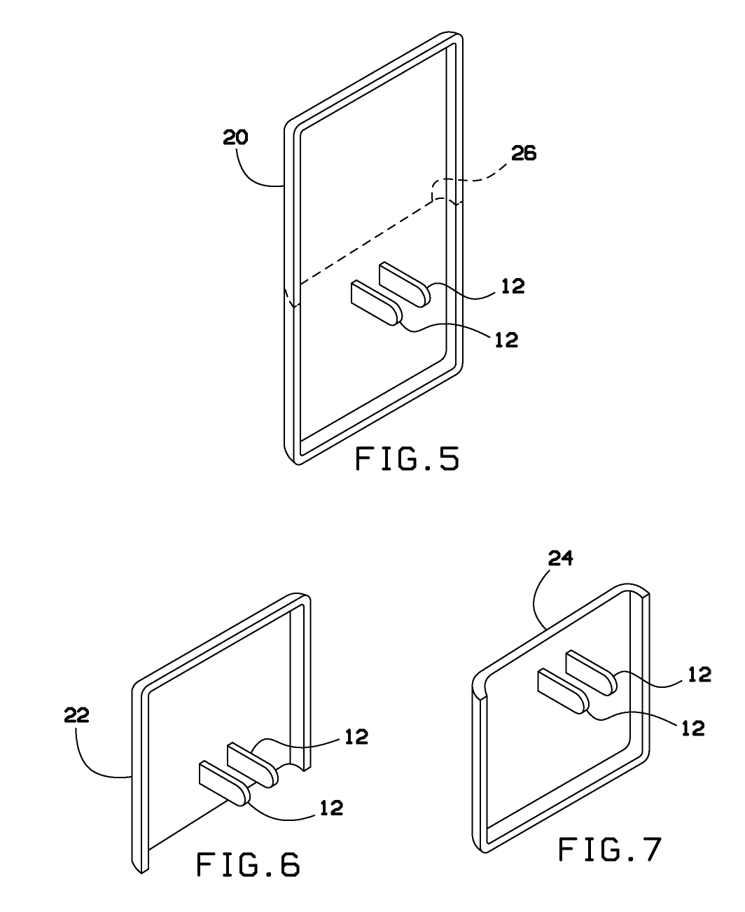

Referring now to FIGS. 5 through 7, a half-size configurable electrical outlet cover 20 can include a separation seam 26 that can be cut to form either a top socket half wall plate cover 22 or a bottom socket half wall plate cover 24. While FIG. 5 shows only a single set of prongs 12, in some embodiments, the half-size configurable electrical outlet cover 20 can include two sets of prongs, where cutting along the separation seam 26 can form both the top socket half wall plate cover 22 and the bottom socket half wall plate cover 24 from a single half-size configurable electrical outlet cover. In some embodiments, the separation seam 26 can be offset from center, where the half wall plate cover 22, 24 formed would cover slightly more than half of the electrical outlet 14.

In some embodiments, the separation seam 28 may be configured to permit a user to remove only an outlet opening from either the top or bottom section of the outlet cover. This would allow access to half of the outlet while covering the entire outlet wall plate 16.

In some embodiments, the outlet cover can be configured as an elongated member having prongs from one side thereof. The elongated member can be designed to fit over one or more outlets in an outlet strip. One or more separation seams can be provided to adjust the size of the outlet cover.

The outlet cover of the present invention can be made from any number of non-conductive materials, such as plastic, nylon, rubber or the like. In some embodiments, the outlet cover is made of a rigid plastic or nylon material, for example. In other embodiments, the outlet cover is made of a more flexible plastic or rubber material, for example.

It should be understood, of course, that the foregoing relates to exemplary embodiments of the invention and that modifications may be made without departing from the spirit and scope of the invention as set forth in the following claims.

What is claimed is:

1. An electrical outlet covering device comprising:
a cover; and
a set of prongs extending from a back side of the cover, the set of prongs operable to fit into an electrical outlet, wherein
the cover is adapted to fit over a wall plate cover of the electrical outlet.

2. The electrical outlet covering device of claim 1, further comprising rounded edges disposed about an outer periphery of the cover.

3. The electrical outlet covering device of claim 1, further comprising a separation seam disposed from a first side to a second side of the cover.

4. The electrical outlet covering device of claim 3, wherein the separation seam is disposed along a center of the cover to divide the cover into two equal portions.

5. The electrical outlet covering device of claim 3, wherein the separation seam is disposed offset of center, wherein a portion of the cover having the set of prongs extending therefrom is longer than a remaining portion of the cover when the cover is separated along the separation seam.

6. An electrical outlet covering device comprising:
a cover;
a set of prongs extending from a back side of the cover, the set of prongs operable to fit into an electrical outlet
rounded edges disposed about an outer periphery of the cover; and
a separation seam disposed from a first side to a second side of the cover, wherein
the cover is adapted to fit over a wall plate cover of the electrical outlet.

7. The electrical outlet covering device of claim 6, wherein the separation seam is disposed along a center of the cover to divide the cover into two equal portions.

8. The electrical outlet covering device of claim 6, wherein the separation seam is disposed offset of center, wherein a portion of the cover having the set of prongs extending therefrom is longer than a remaining portion of the cover when the cover is separated along the separation seam.

9. An electrical outlet covering device comprising:
a cover; and
a set of prongs extending from a back side of the cover, the set of prongs operable to fit into an electrical outlet, wherein
the cover is adapted to fit over half or more of a wall plate cover of the electrical outlet.

10. The electrical outlet covering device of claim 9, further comprising rounded edges disposed about an external periphery of the cover.
